(19) United States
(12) Patent Application Publication
(10) Pub. No.: US 2002/0095437 A1
(43) Pub. Date: Jul. 18, 2002

(54) Information processing apparatus, method for utilizing the same and program for information processing apparatus

(76) Inventor: Keiichi Sugiyama, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/043,163

(22) Filed: Jan. 14, 2002

(30) Foreign Application Priority Data
Jan. 17, 2001 (JP) 2001-009007

(51) Int. Cl. G06F 9/00

(52) U.S. Cl. 707/204

(57) ABSTRACT

An information processing apparatus is provided with an interface and a storage device which stores a program. The program includes a detecting routine which detects whether or not an external device is connected to the interface, a judgment routine which judges whether or not the external device is a storage device which stores an operating system in the case where an external device is detected by the detecting routine, and a starting-up routine which starts up the operating system in the case where the external device is judged to be a storage device which stores an operating system by the judgment routine.

### BACKGROUND OF THE INVENTION

1. Field of the Invention

The present invention relates to an information processing apparatus for operating a plurality of operating systems, a method for using the same and a program for the information processing apparatus, in particular, to an information processing apparatus which improves operability of users, a method for utilizing the same and a program for the information processing apparatus.

2. Description of the Related Art

A personal computer system is disclosed in Japanese Unexamined Patent Publication No. Hei 5-73278. In the personal computer system, a memory card slot into which a BIOS (basic input/output system) card can be inserted or removed is provided in the body of a personal computer. One BIOS card according to the purpose of utilization is mounted in the slot from among a plurality of BIOS cards which have been prepared in advance. The program is mapped in the BIOS region on the memory map of the body. In such a personal computer system BIOS-ROMs are provided in a card form so that it is easy to replace the BIOS.

In addition, a computer system is disclosed in Japanese Unexamined Patent Publication No. 2000-330806. In the computer system, a plurality of operating systems (hereinafter referred to as “OS”) are utilized. In addition, an OS context switch for switching the implementation environment and a common interruption handler for allocating interruptions that have occurred in respective OSs are provided. Then, a priority interruption table for storing OSs that start up for respective interruption factors is referred to by the common interruption handler and the OS context switch is required to switch to the OS in accordance with the interruption factor. At the same time the interruption handler is made to start up. In such a computer system, it is possible to operate a plurality of different OSs with a single processor.

In the technology described in Japanese Unexamined Patent Publication No. Hei 5-73278, however, the interface for connecting BIOS cards does not allow live lines to be inserted or to be removed. Therefore, a BIOS cannot be replaced in the condition wherein the power supply of the computer is turned on. Accordingly, in the case where a BIOS that is being utilized is replaced with another BIOS, operations are required once the power supply of the computer or the like is turned off, or mapping is carried out in the BIOS region on the memory map. As a result of that, users are forced to carry out troublesome operations.

In addition, in the technology described in the Japanese Unexamined Patent Publication No. 2000-330806, it is necessary to download a plurality of OSs into the computer in advance. Therefore, it is essential to make the capacity of the storage device large so that each OS can be stored. In addition, in the case where a plurality of OSs are downloaded into a computer, the processing speed of the computer may be reduced.

### SUMMARY OF THE INVENTION

It is an object of the present invention to provide an information processing apparatus which can reduce the number of operations carried out by users without making the capacity of the storage device in the computer large and without reducing the processing speed of the computer, a method for utilizing the same and a program for the information processing apparatus.

An information processing apparatus according to the present invention comprises an interface and a storage device which stores a program. The program comprises a detecting routine which detects whether or not an external device is connected to the interface, a judgment routine which judges whether or not the external device is a storage device which stores an operating system in the case where an external device is detected by the detecting routine, and a starting-up routine which starts up the operating system in the case where the external device is judged to be a storage device which stores an operating system by the judgment routine.

A method for utilizing an information processing apparatus according to the present invention comprises the steps of making the information processing apparatus detect whether or not an external device is connected to an interface provided to the information processing apparatus, making the information processing apparatus judge whether or not the external device is a storage device which stores an operating system in the case where an external device has been detected, and making the information processing apparatus start up the operating system in the case where the external device has been judged to be a storage device which stores an operating system.

A program for an information processing apparatus according to the present invention comprises a detecting routine which detects whether or not an external device is connected to the interface, a judgment routine which judges whether or not the external device is a storage device which stores an operating system in the case where an external device is detected by the detecting routine, and a starting-up routine which starts up the operating system in the case where the external device is judged to be a storage device which stores an operating system by the judgment routine.

### BRIEF DESCRIPTION OF THE DRAWINGS

FIG. 1 is a block diagram showing a schematic configuration of a computer system according to an embodiment of the present invention; and

FIG. 2 is a flow chart showing a procedure of the operations of the computer system according to the embodiment of the present invention.

### DETAILED DESCRIPTION OF THE PREFERRED EMBODIMENTS

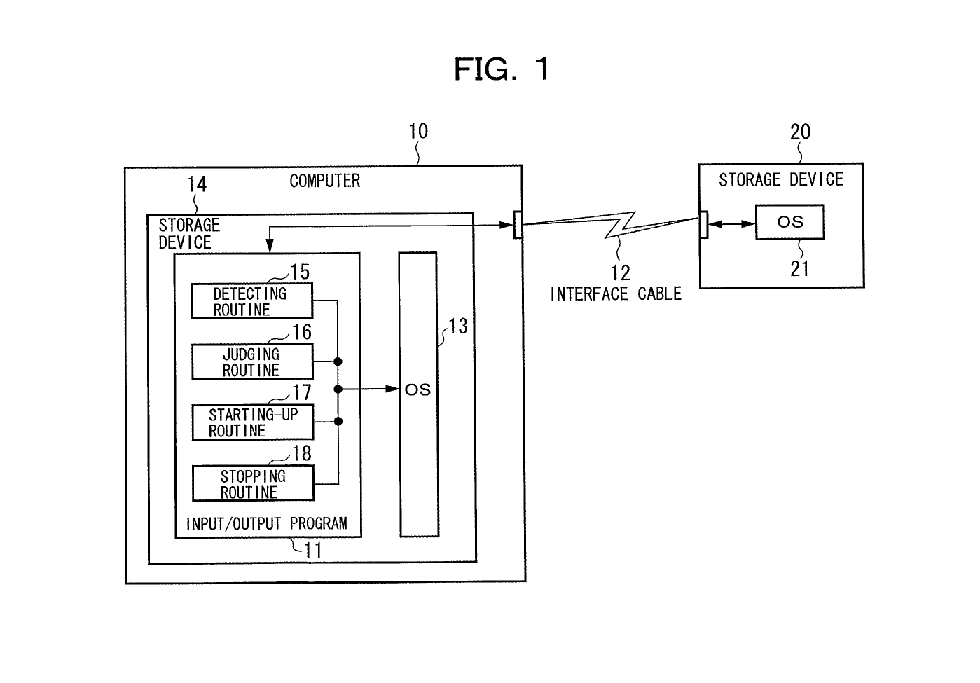

The preferred embodiments of the present invention are explained below with reference to the accompanying drawings. FIG. 1 is a block diagram showing a schematic configuration of a computer system according to an embodiment of the present invention.

The present embodiment is provided with a computer 10 such as a personal computer as an information processing apparatus and with a storage device 20 such as a hard disk drive, a CD-ROM (compact disk read only memory) drive or the like. The computer 10 and the storage device 20 are connected to each other by an interface cable 12, such as USB (Universal Serial Bus), IEEE (Institute of Electrical and Electronics Engineers, Inc.) 1394, or the like, which makes the insertion and removal of live lines possible. The computer 10 is provided with, for example, an interface to which the interface cable 12 is connected, a central processing unit (CPU), a processor, a data processing unit, and the like. The storage device 20 is provided with, for example, an interface to which the interface cable 12 is connected.

The computer 10 is provided with a storage device 14 such as a hard disk drive, an EEPROM (Electrically Erasable Programmable ROM), or the like. In the storage device 14, an OS 13 having high utilization frequency and an input/output program (BIOS) 11 for controlling the OS 13 and a variety of devices such as a keyboard, a floppy disk drive, a hard disk drive, or the like, which are connected to the computer 10, are stored.

An OS 21 of which the utilization frequency is low is, for example, stored in the storage device 20 so that the start-up and the operation of the OS 21 are carried out regardless of whether or not the OS 13 is started up.

In the case where an IEEE 1394 interface cable is utilized as the interface cable 12, 63 external devices such as a storage device, at most, can be serially connected. Therefore, a plurality of OSs can be operated by the computer 10 without being installed in the computer 10.

The input/output program 11 includes a detecting routine 15, a judgment routine 16, a starting-up routine 17 and a stopping routine 18. It is detected by the detecting routine 15 whether or not devices are connected through the interface 12. It is judged by the judgment routine 16, in accordance with the detection result of the detecting routine 15, which type the external devices which are connected through the interface cable 12 are. The OS 21 is started up by the starting-up routine 17 in the case where the judgment routine 16 has judged that the storage device 20 is connected through the interface cable 12. The OS 13 is stopped by the stopping routine 18 prior to the start-up of the OS 21 by the starting-up routine 17.

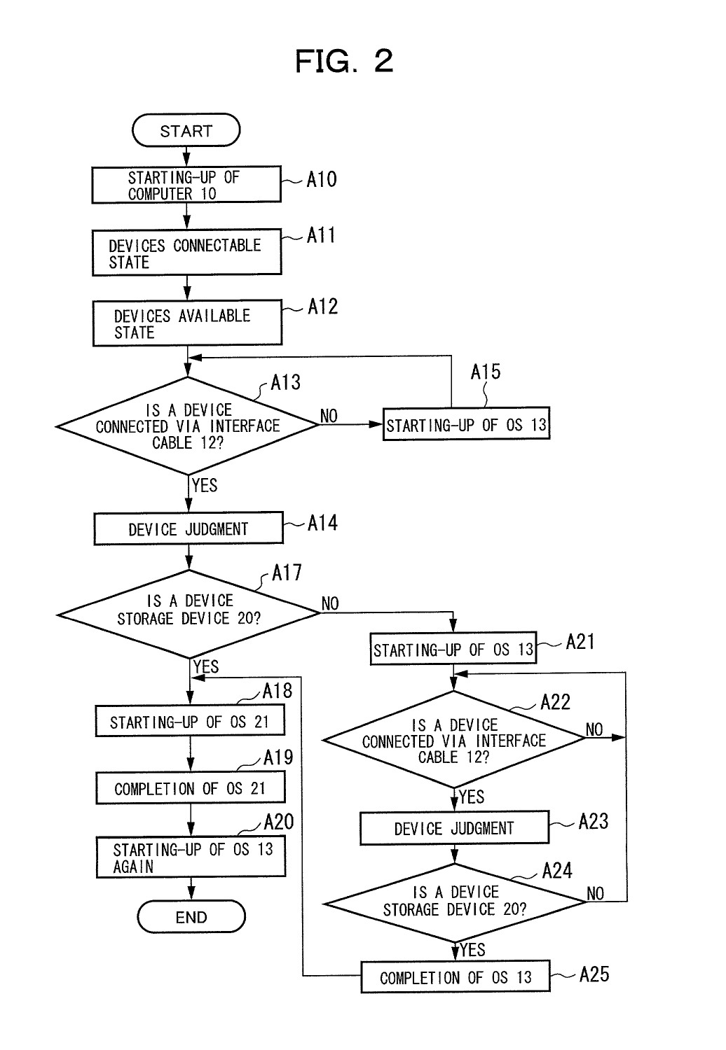

Next, the operation of the computer system configured in the above manner is described. FIG. 2 is a flow chart showing the operation of the computer system according to the embodiment of the present invention. In this operation, the input/output program 11 is constructed by a user or the like, so that the storage device 20 starts up before the storage device 14 starts.

First, when a user turns on the power supply of the computer 10 (step A10), the input/output program 11 is started up.

The input/output program 11 converts the system to a state that allows the connection of external devices via interface cables including the interface cable 12 (step A11), and converts the system to a state that allows the utilization of the external devices (step A12). Then, it is detected by the detecting routine 15 whether or not an external device is connected via the interface cable 12 or the like (step A13). In the case where an external device is not found, as a result of the detection, to be connected via the interface cable 12, the OS 13 is started up (step A15) and the procedure returns to step A13.

In the case where the detecting routine 15 detects that at least one external device is connected via the interface cable 12 or the like, the judgment routine 16 judges the type of the external device (step A14), and, after that, the procedure goes to step A17.

In step A17, in the case where the external device connected via the interface cable 12 has been judged to be the storage device 20 in the step 14, the procedure goes to step A18.

In addition, in the case where the external device connected via the interface cable 12 has not been judged to be the storage device 20, the procedure goes to step A21, and, after that, the same procedures as in steps A13, A14 and A17 are carried out (steps A22 to A24). In step A24, in the case where the external device connected via the interface cable 12 has been judged to be the storage device 20, the operation of the OS 13 is stopped (unloaded) by the stopping routine 18 (step A25), and the procedure goes to step A18.

In step A18, the OS 21 is started up. After that, however, in the case where the storage device 20 is removed from the computer 10 or the operation of the OS 21 is completed through operation by a user or the like, and such a state is then detected by the detecting routine 15 (step A19), the OS 13 is started up again (step A20), and the procedure shown in FIG. 2 is completed.

According to the present embodiment, in the case where the device connected to the body of the information processing apparatus is a storage device which stores an operating system, this operating system is started up with a high priority, so that the number of operations carried out by users is reduced. In addition, it is not necessary to make the capacity of the storage device within the computer large and the processing speed of the computer is not reduced.

In the present embodiment, the operation of the computer shown in FIG. 1 is described by citing, as an example, the case where the input/output program 11 is constructed by a user or the like, so that the storage device 20 starts up prior to the storage device 14. The storage device 14 may start up prior to the storage device 20, and, when the detecting routine 15 detects the connection of the storage device 20, the start-up of the OS 13 may be stopped by the stopping routine 18 and the OS 21 may be started up by the starting-up routine 17.

What is claimed is:

1. An information processing apparatus comprising:
an interface; and
a storage device which stores a program, said program comprising:
a detecting routine which detects whether or not an external device is connected to said interface;
a judgment routine which judges whether or not said external device is a storage device which stores an operating system in the case where an external device is detected by said detecting routine; and
a starting-up routine which starts up said operating system in the case where said external device is judged to be a storage device which stores an operating system by said judgment routine.

2. The information processing apparatus according to claim 1, wherein said program comprises a stopping routine which stops start-up of a second operating system in the case where said second operating system has been started up, before said operating system stored in said storage device is started up by said starting-up routine.

3. The information processing apparatus according to claim 1, wherein said program is an input/output program.

4. The information processing apparatus according to claim 2, wherein said program is an input/output program.

5. The information processing apparatus according to claim 2, wherein said starting-up routine starts up said second operating system after the operation of said operating system stored in said storage device is completed.

6. The information processing apparatus according to claim 3, wherein said starting-up routine starts up said second operating system after the operation of said operating system stored in said storage device is completed.

7. The information processing apparatus according to claim 4, wherein said starting-up routine starts up said second operating system after the operation of said operating system stored in said storage device is completed.

8. The information processing apparatus according to claim 1, wherein said external device is connected to said interface via an interface cable which allows a live line to be inserted and to be removed.

9. The information processing apparatus according to claim 2, wherein said external device is connected to said interface via an interface cable which allows a live line to be inserted and to be removed.

10. The information processing apparatus according to claim 3, wherein said external device is connected to said interface via an interface cable which allows a live line to be inserted and to be removed.

11. The information processing apparatus according to claim 4, wherein said external device is connected to said interface via an interface cable which allows a live line to be inserted and to be removed.

12. The information processing apparatus according to claim 5, wherein said external device is connected to said interface via an interface cable which allows a live line to be inserted and to be removed.

13. The information processing apparatus according to claim 6, wherein said external device is connected to said interface via an interface cable which allows a live line to be inserted and to be removed.

14. The information processing apparatus according to claim 7, wherein said external device is connected to said interface via an interface cable which allows a live line to be inserted and to be removed.

15. A method for utilizing an information processing apparatus comprising the steps of:
making said information processing apparatus detect whether or not an external device is connected to an interface provided to said information processing apparatus;
making said information processing apparatus judge whether or not said external device is a storage device which stores an operating system in the case where an external device has been detected; and
making said information processing apparatus start up said operating system in the case where said external device has been judged to be a storage device which stores an operating system.

16. A program for an information processing apparatus comprising:
a detecting routine which detects whether or not an external device is connected to said interface;
a judgment routine which judges whether or not said external device is a storage device which stores an operating system in the case where an external device is detected by said detecting routine; and
a starting-up routine which starts up said operating system in the case where said external device is judged to be a storage device which stores an operating system by said judgment routine.
